(19) United States
(12) Patent Application Publication
(10) Pub. No.: US 2011/0035774 A1
(43) Pub. Date: Feb. 10, 2011

(54) PREVIOUSLY VIEWED CHANNEL QUICK BAR

(75) Inventor: Scott Parker, Aurora, CO (US)

Correspondence Address: INGRASSIA FISHER & LORENZ, P.C. (EchoStar), 7010 E. COCHISE ROAD, SCOTTSDALE, AZ, 85253, US

(73) Assignee: ECHOSTAR TECHNOLOGIES LLC, Englewood, CO (US)

(21) Appl. No.: 12/537,943

(22) Filed: Aug. 7, 2009

(51) Int. Cl. H04N 5/445; H04N 7/173

(52) U.S. Cl. 725/40; 725/44; 725/131; 715/721

(57) ABSTRACT

Methods are provided for storing and retrieving recently viewed programming channel information in a last-in-first-out (LIFO) memory register. The programming channel information comprises previously viewed channel information and subsequently viewed channel information where the previously viewed channel information is stored prior to the subsequently viewed channel information in the order of viewing. The methods also include, receiving a viewer instruction to render the imagery on the display device and reading the programming channel information from the LIFO register. The previously viewed channel information is read from the LIFO memory register after the subsequently viewed programming channel information is read in the reverse order of viewing. The method further includes the functions of modifying an imagery file associated with the imagery being rendered with the programming channel information and rendering the modified imagery to the user on the display device.

### TECHNICAL FIELD

The present invention generally relates to user interfaces in television receiver devices, and more particularly relates to systems and methods for providing graphical adjustment and control of numeric, alphanumeric and/or other symbol-based features provided by a television receiver device.

### BACKGROUND

Most television viewers now receive their television signals through a content aggregator such as a cable or satellite television provider. For subscribers to a direct broadcast satellite (DBS) service, for example, television programming is received via a broadcast that is sent via a satellite to an antenna that is generally located on the exterior of a home or other structure. Other customers receive television programming through conventional television broadcasts, or through cable, wireless or other media. Programming is typically received at a receiver such as a “set top box” (STB) or other receiver that demodulates the received signals and converts the demodulated content into a format that can be presented to the viewer on a television or other display. In addition to receiving and demodulating television programming, many television receivers are able to provide additional features. Examples of features available in many modern television receivers include electronic program guides (EPGs), digital or other personal video recorders, “place-shifting” features for streaming received content over a network or other medium, providing customer service information and/or the like.

Generally speaking, viewers interact with the STB or other receiver using some sort of user interface that receives inputs from a remote control or other input device. To change a channel, for example, the viewer typically depresses a “channel up/down” button, manually enters a number of a desired channel on a numeric keypad, and/or selects the new channel using a program guide feature of the receiver. Alternatively, viewers can often seek out programs using an EPG feature provided by the receiver. The EPG generally provides comprehensive lists of programs and associated information, and allows viewers to readily tune to programs currently being shown. Many EPGs also allow viewers to set a recording for a future event, or to take other actions as appropriate.

While conventional interfaces are useful for many purposes, there remains a continual desire for more efficient and intuitive user interfaces to the various features provided by the receiver. In particular, there is a desire to provide convenient access to numeric features (e.g., channel numbers) without using a numeric keypad. It is therefore desirable to create systems and methods for improving the viewer interface to the television receiver. These and other desirable features and characteristics will become apparent from the subsequent detailed description and the appended claims, taken in conjunction with the accompanying drawings and this background section.

### BRIEF SUMMARY

According to various exemplary embodiments and methods are provided for graphically providing a previously viewed channel quick bar. Such methods include the function of storing recently viewed programming channel information in a last-in-first-out (LIFO) memory register. The programming channel information comprises previously viewed channel information and subsequently viewed channel information where the previously viewed channel information is stored prior to the subsequently viewed channel information in the order of viewing. The method also includes, receiving a viewer instruction to render the imagery on the display device; and reading the programming channel information from the LIFO register. The previously viewed channel information is read from the LIFO memory register after the subsequently viewed programming channel information is read in the reverse order of viewing. The method further includes the functions of modifying an imagery file associated with the imagery being rendered with the programming channel information and rendering the modified imagery to the user on the display device.

Methods to create previously viewed data are also provided. The methods include selecting a channel to be viewed and determining whether a minimum viewing time has been achieved. If the minimum viewing time has not been achieved then repeating the selecting and determining functions. However, if the minimum viewing time has been achieved then storing data associated with the viewed channel as previously viewed channel data.

A computer readable storage medium is provided that contains instructions that when executed by a computing device stores recently viewed programming channel information in a last-in-first-out (LIFO) memory register. The programming channel information comprises previously viewed channel information and subsequently viewed channel information and is stored prior to the subsequently viewed channel information in the order of viewing. The method also receives a viewer instruction to render the imagery on the display device and reads the programming channel information from the LIFO register. The previously viewed channel information is read from the LIFO memory register after the subsequently viewed programming channel information is read in the reverse order of viewing. Further an imagery file associated with the imagery being rendered is modified with the programming channel information and the modified imagery is rendered on the display device.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary television receiver system including subject matter disclosed herein;

FIG. 2 is a block diagram of an exemplary television receiver device;

FIG. 3 is a diagram of an exemplary screen display for receiving and processing numeric inputs from the viewer; and

FIG. 4 is a flowchart showing an exemplary process for storing and displaying recently viewed channels in a television receiver or other device.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Generally speaking, the viewer is able to provide numeric, alpha-numeric or other symbol based inputs to a television receiver using two-dimensional or other user interface features. A keypad representing the various symbols is graphically presented on the display, and the viewer is able to interact with the keypad imagery using a cursor or other interface feature that can be moved in response to two-dimensional (2-D) inputs applied at a touchpad, motion sensor or other sensor device associated with the remote control. In embodiments wherein the remote control includes a touchpad or similar control device but does not include a numeric keypad, for example, a viewer may nevertheless be able to provide numeric (or alphanumeric) inputs to the receiver by directing a cursor presented as part of the on-screen imagery. The cursor may be able to select numbers, letters and/or other features in order to tune channels or perform other tasks as desired. Other conveniences such as quick reference features may be provided as well.

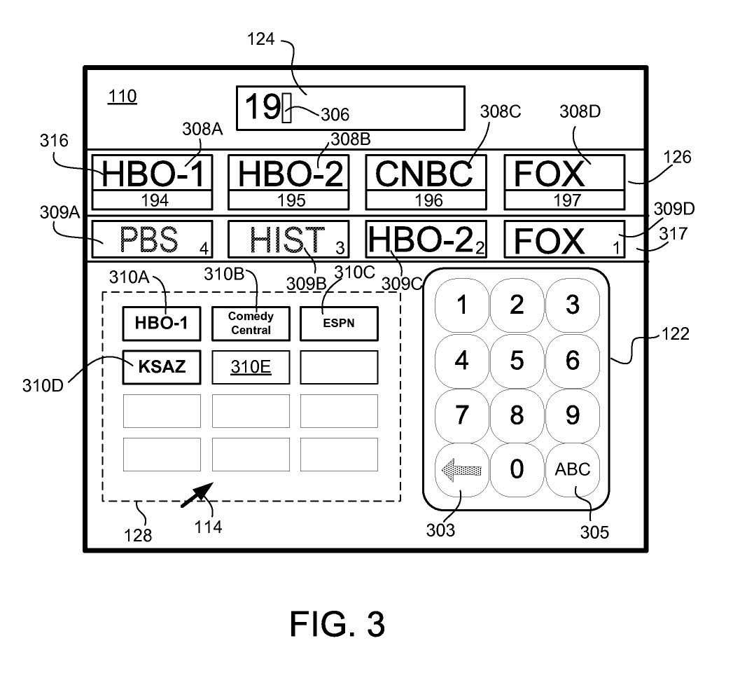

More specifically, the viewer is able to use 2-D inputs from a remote control device remote to tune in a channel to view from a list of recently viewed video channels that have been saved by the television receiver on a last-in-first out (LIFO) basis. The list of recently viewed channels (a/k/a a “previously viewed channel quick bar”) may be disabled or may be locked or otherwise prevented from adding additional previously viewed channels to the LIFO list. An exemplary rendition of a user interface that may be used to display the list of recently viewed channels is presented in FIG. 3, which will be discussed in detail below.

Although the various techniques and systems described herein may be used with any sort of remote control or command equipment, various embodiments may be particularly well suited for use with a remote control that includes a touchpad, directional pad, joystick, trackball, set of directional buttons, motion sensor and/or other feature capable of providing two-dimensional inputs to the receiver. While the discussion herein focuses primarily on entering channel numbers, equivalent concepts could be readily applied to other numeric or alphanumeric features provided by the television receiver. Onscreen keypads may be fashioned to show any number of letters, numbers and/or other symbols (including foreign language symbols), thereby allowing the various principles and concepts presented herein to be applied in a wide variety of settings, applications and embodiments.

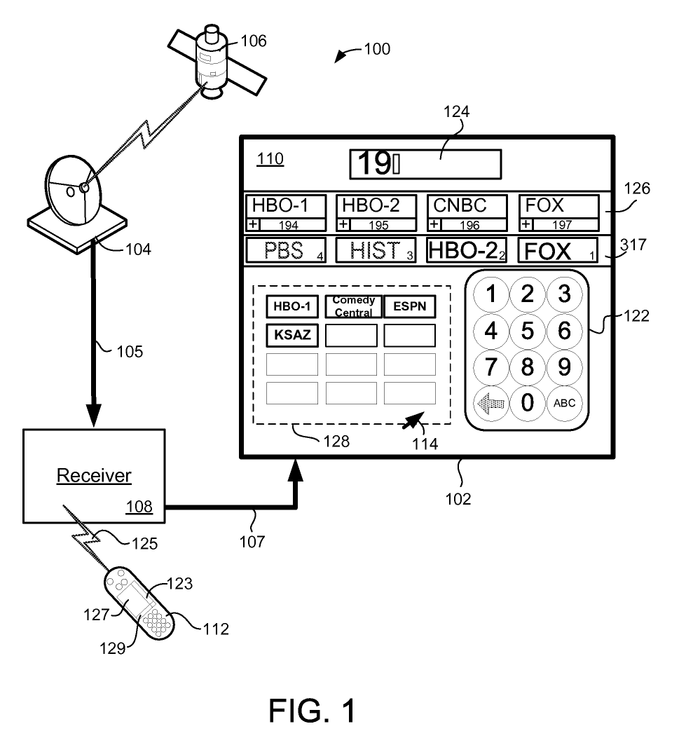

Turning now to the drawing figures and with initial reference to FIG. 1, an exemplary system 100 for presenting television signals to a viewer suitably includes a receiver 108 that receives signals 105 in any format and generates appropriate outputs 107 to generate imagery 110 on a display 102. Typically, receiver 108 interacts with signals 125 received from a wireless remote control 112 to present television imagery 110 on display 102 as desired by the viewer.

In the exemplary view shown in FIG. 1, imagery no includes a numeric, alphanumeric or other keypad 122 that allows for symbol-based data entry using cursor 114. Imagery no also includes a symbol display window 124, a channel indicator window 126, and a quick reference area 128 as desired. The various features presented in imagery 110 may vary widely from embodiment to embodiment. The relative spacing, proportions and locations of the various windows and other features described herein, for example, are entirely exemplary, and may vary widely in other embodiments. Other embodiments may similarly add or omit certain features, or use the various features for purposes other than those described herein.

Television imagery is presented on display 102 as desired by the viewer. Further, two-dimensional navigation features may be presented to allow the viewer to enter symbol-type or other data through control of a cursor 114 or other interface feature via remote control 112. In various embodiments, cursor 114 is able to move in response to two-dimensional input signals 125, which are, in turn, generated in response to inputs applied to two-dimensional input device 127. By moving cursor 114 to interact with the two-dimensional navigation features presented on display 102, numeric, alphanumeric and/or other data may be entered, recalled and/or otherwise manipulated as desired.

Receiver 108 is any component, device or logic capable of receiving and decoding video signals 105. In various embodiments, receiver 108 is a set-top box (STB) or the like capable of receiving satellite, cable, broadcast and/or other signals encoding audio/visual content. Receiver 108 may further demodulate or otherwise decode the received signals 105 to extract programming that can be locally viewed on display 102 as desired. Receiver 108 may also include a content database stored on a hard disk drive, memory, or other storage medium to support a digital or other personal video recorder (DVR/PVR) feature in some embodiments. Receiver 108 may also provide place shifting, electronic program guide, multi-stream viewing and/or other features as appropriate.

In the exemplary embodiment illustrated in FIG. 1, receiver 108 is shown receiving digital broadcast satellite (DBS) signals 105 from a satellite 106 at an antenna for a receiver 104. Equivalent embodiments, however, could receive programming 105 from one or more programming sources, including any sort of satellite, cable or broadcast source, as well as any Internet or other network source or the like. In embodiments that include DVR functionality, programming may be stored in any sort of database as desired (e.g., in response to user/viewer programming instructions) for subsequent viewing. Content may also be received from digital versatile disks (DVDs) or other removable media in some embodiments.

Display 102 is any device capable of presenting imagery no to a viewer. In various embodiments, display 102 is a conventional television set, such as any sort of television operating in accordance with any digital or analog protocols, standards or other formats. Display 102 may be a conventional NTSC or PAL television receiver, for example. In other embodiments, display 102 is a monitor or other device that may not include built-in receiver functionality, but that is nevertheless capable of presenting imagery in response to signal 107 received from receiver 108. In various embodiments, receiver 108 and display 102 may be physically combined or interconnected in any manner. A receiver card, for example, could be inserted into a slot or other interface in a conventional television, or the functionality of receiver 108 may be provided within a conventional television display 102. In other embodiments, signals 107 are transferred between receiver 108 and display 102 using any sort of cable or other interface (including a wireless interface). Examples of common interfaces include, without limitation, component video, S-video, High-Definition Multimedia Interface (HDMI), Digital Visual Interface (DVI), IEEE 1394, and/or any other formats as desired.

Remote control 112 is any sort of control device capable of providing signals 125 to receiver 108 that represent inputs received from one or more viewers. Typically, remote control 112 is an infrared, radio frequency (RF) or other wireless remote that includes any number of buttons or other features for receiving viewer inputs. In an exemplary embodiment, remote control 112 communicates with receiver 108 using the IEEE 802.15.4 (“ZIGBEE”) protocol for wireless personal area networks (WPANs), although other embodiments may instead communicate using IEEE 802.15.1 (“BLUETOOTH”), IEEE 802.11 (“WI-FI”), conventional infrared, and/or any other wireless techniques. In some embodiments, remote control 112 may be able to support multiple types of wireless communication, such as ZIGBEE communications and also infrared communications. This feature may be useful when remote control 112 is a so-called universal remote that is able to provide input signals 125 to multiple devices.

Remote control 112 generally includes any sort of buttons, sliders, rocker switches and/or other features for receiving physical inputs from the viewer. As the user depresses or otherwise interacts with the features, remote control 112 suitably produces wireless signals 125 in response. In further embodiments, remote control 112 includes a two-dimensional input device 127 that is able to receive inputs from the user in any multi-dimensional format (e.g., “X,Y”, “r,Θ”, and/or the like).

Examples of two-dimensional input devices 127 that could be used in various embodiments include, without limitation, touchpads, directional pads, joysticks, trackballs, sets of arrows or other buttons, and/or the like. In a typical implementation, two-dimensional input device 127 provides coordinates or other signals 125 that indicate absolute (e.g., “X,Y”) and/or relative (e.g., “ΔX,ΔY”) movement in two or more dimensions. Such signals 125 may be decoded at controller 108 or elsewhere to coordinate the viewer's actions with respect to input device 127 to movement of cursor 114 or other features presented on display 102.

In the exemplary embodiment shown in FIG. 1, remote control 112 is illustrated with a two dimensional touchpad-type device 127 that accepts viewer inputs applied with a finger, stylus or other object. FIG. 1 also shows touchpad device 127 as having dedicated scroll regions 123 and 129 for vertical and horizontal scrolling, respectively. Viewer movements within region 123 that are more-or-less parallel to the right edge of device 127, for example, could result in vertical scrolling, whereas movements within region 128 that are more-or-less parallel to the bottom edge of device 127 could result in horizontal scrolling. Dedicated scrolling regions 123, 128 are optional features, however, that may not be present in all embodiments. Further, scrolling could be implemented in any other manner.

In operation, then, receiver 108 suitably receives television signals 105 from a satellite, cable, broadcast or other source. In a satellite based embodiment, for example, one or more channels can be extracted from a conventional satellite feed; the video content on the selected channel can be demodulated, extracted and otherwise processed as appropriate to display the desired content to the viewer. One or more cable or broadcast channels may be similarly obtained in any manner. In some embodiments, receiver 108 may obtain multiple channel signals from different sources (e.g., one channel from a cable or satellite source and another channel from a terrestrial broadcast, DVD or other source).

Receiver 108 suitably obtains the desired content from the channel(s) indicated by the viewer, and presents the content on display 102. In various embodiments, viewers are able to further view imagery (e.g., the imagery 110 shown in FIG. 1) that allows for numeric, alphanumeric or other symbol-based inputs to be generated using remote control 112, even though remote control 112 may not have keys or buttons corresponding to some or all of the symbols entered. By moving cursor 114 with respect to imagery 110, for example, a “virtual keypad” can be created that allows symbol-type inputs to be generated. A viewer may enter numerals, for example, by directing cursor 114 toward the desired numeral in keypad 122, and then depressing a select or enter key on the remote 112 to select the indicated symbol. Entered symbols may be displayed or otherwise processed as desired. In the exemplary embodiment shown in FIG. 1, numeric inputs are used to select a television channel to be decoded and presented on display 102. In some embodiments, channel numbers generated with keypad 122 are presented in display window 124 and are also used to select titles, tiles or other indicators in channel indicator window 126. These indicators can be selected (e.g., with cursor 114) to directly tune the indicated channel, or one or more indicated channels may be saved in quick retrieval window 128 for later tuning. Other channel tuning implementations may provide widely varying layouts and features; still other embodiments may use symbol-based inputs for completely different functions, such as searching for programs in an EPG, DVR, network server or other program source, or any other function as desired. FIG. 1 also presents a recently viewed identifier window 317, the operation of which will be disclosed in more detail below and in FIG. 3

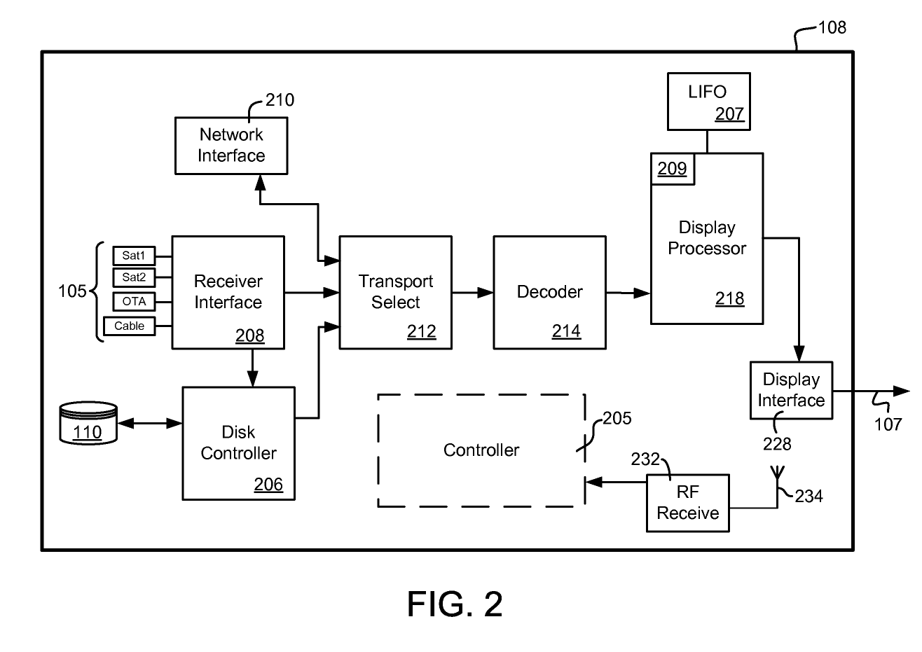

FIG. 2 provides additional detail about an exemplary receiver 108 that includes a receiver interface 208, a decoder 214 and a display processor 218, as appropriate. FIG. 2 also shows a disk controller interface 206 to a disk or other storage device 211, an interface to a LIFO memory register 207, an interface 210 to a local or wide area network, a transport select module 212, a display interface 228, an RF receiver module and control logic 205. Other embodiments may incorporate additional or alternate processing modules from those shown in FIG. 2, may omit one or more modules shown in FIG. 2, and/or may be differently organize the various modules in any other manner different from the exemplary arrangement shown in FIG. 2.

For example the LIFO memory register 207 may be a component of the disk controller 206, display processor 209 or some other sub assembly of the receive 108. The LIFO register 207 may also be a standalone component in alternative embodiments. Those of ordinary skill in that art will appreciate that a the LIFO register 207, a flash memory, a magnetic disk a memory register, a programmable logic devices, Read-only memory, optical disks, volatile memory, non-volatile memory, random access memory, electronically erasable read only memory and any other memory device developed now or in the future are non-limiting examples of a computer readable media.

Receiver 108 may be physically and logically implemented in any manner. FIG. 2 shows various logical and functional features that may be present in an exemplary device; each module shown in the figure may be implemented with any sort of hardware, software, firmware and/or the like. Any of the various modules may be implemented with any sort of general or special purpose integrated circuitry, for example, such as any sort of microprocessor, microcontroller, digital signal processor, programmed array and/or the like. Any number of the modules shown in FIG. 2, for example, may be implemented as a “system on a chip” (SoC) using any suitable processing circuitry under control of any appropriate control logic 205. In various embodiments, control logic 205 executes within an integrated SoC or other processor that implements receiver interface 208, transport selector 212, decoder 214, display processor 218, disk controller module 206 and/or other features, as appropriate. The Broadcom Corporation of Irvine, Calif., for example, produces several models of processors (e.g., the model BCM 7400 family of processors) that are capable of supporting SoC implementations of satellite and/or cable receiver systems, although products from any number of other suppliers could be equivalently used. In still other embodiments, various distinct chips, circuits or components may be inter-connected and inter-relate with each other to implement the receiving and decoding functions represented in FIG. 2. Those of ordinary skill in the art will appreciate that any of a processor, a microprocessor, a microcontroller, a digital signal processor, a programmed array and any functionally similar computing devices are all non-limiting examples of computer readable storage media.

Various embodiments of receiver 108 therefore include any number of appropriate modules for obtaining and processing media content as desired for the particular embodiment. Each of these modules may be implemented in any combination of hardware and/or software using logic executed within any number of semiconductor chips or other processing logic.

Various embodiments of control logic 205 can include any circuitry, components, hardware, software and/or firmware logic capable of controlling the various components of receiver 108. Various routines, methods and processes executed within receiver 108 are typically carried out under control of control logic 205, as described more fully below. Generally speaking, control logic 205 receives user input signals 125 (FIG. 1) via an RF receiver interface 232 that is able to communicate with the remote control 112 using a suitable antenna 234. Control logic receives user inputs from remote control 112 and/or any other source, and directs the other components of receiver 108 in response to the received inputs to present the desired imagery on display 102.

As noted above, receiver 108 suitably includes a receiver interface 208, which is any hardware, software, firmware and/or other logic capable of receiving media content via one or more content signals 105. In various embodiments, signals 105 may include cable television, direct broadcast satellite (DBS), broadcast and/or other programming signals as appropriate. Receiver interface 208 appropriately selects a desired input source and provides the received content to an appropriate destination for further processing. In various embodiments, received programming may be provided in real-time (or near real-time) to a transport stream select module 212 or other component for immediate decoding and presentation to the user. Alternatively, receiver interface 208 may provide content received from any source to a disk or other storage medium in embodiments that provide DVR functionality. In such embodiments, receiver 108 may also include a disk controller module 206 that interacts with an internal or external hard disk, memory, memory register 207 and/or other device that stores content in a database 110, as described above.

In the embodiment shown in FIG. 2, receiver 108 also includes an appropriate network interface 210, which operates using any implementation of protocols or other features to support communication by receiver 108 on any sort of local area, wide area, telephone and/or other network. In various embodiments, network interface 210 supports conventional LAN, WAN or other protocols (e.g., the TCP/IP or UDP/IP suite of protocols widely used on the Internet) to allow receiver 108 to communicate on the Internet or any other network as desired. Network interface 210 typically interfaces with the network using any sort of LAN adapter hardware, such as a conventional network interface card (NIC) or the like provided within receiver 108. Other embodiments may provide interfaces 210 to conventional telephone lines or other communications channels, or may omit network connectivity altogether.

Transport stream select module 212 is any hardware and/or software logic capable of selecting a desired media stream from the available sources. In the embodiment shown in FIG. 2, stream select module 212 is able to generate video signals for presentation on one or more output interfaces 228. Typically, transport select module 212 responds to viewer inputs (e.g., via control logic 205) to simply switch encoded content received from a broadcast, satellite, cable or other source signal 105 or from storage 110 to one or more decoder modules 214.

Receiver 108 may include any number of decoder modules 214 for decoding, decompressing and/or otherwise processing received/stored content as desired. Generally speaking, decoder module 214 decompresses, decodes and/or otherwise processes received content from stream select module 212 to extract an MPEG or other media stream encoded within the stream. The decoded content can then be processed by one or more display processor modules 218 to create a presentation on display 102 (FIG. 1) for the viewer in any appropriate format. FIG. 2 shows a single decoder module 214 operating on one television signal received from transport select module 212. In practice, any number of decoder modules 214 may be used, particularly in “picture in picture” (PIP) situations when multiple signals are simultaneously decoded and displayed. The term “decoder”, then, may collectively apply to one or more decoder modules that are able to decode one or more signals for presentation on display.

Display processor module 218 includes any appropriate hardware, software and/or other logic to create desired screen displays via display interface 228 as desired. Such displays may include combining signals received from one or more decoder modules 214 to facilitate viewing of one or more channels. In various embodiments, display processing module 218 is also able to produce on screen displays (OSDs) for electronic program guide, setup and control, input/output facilitation and/or other features that may vary from embodiment to embodiment. Such displays are not typically contained within the received or stored broadcast stream, but are nevertheless useful to users in interacting with receiver 108 or the like. The generated displays, including received/stored content and any other displays may then be presented to one or more output interfaces 228 in any desired format. The various interface features described herein, for example, may be generated by display processor module 218 operating alone or in conjunction with control logic 205.

Display processor module 218 may also include a viewing timer 209. The viewing timer 209 may be used for a number of functions that may include determining whether a selected channel is a viewed channel or whether the selected channel may be a channel temporarily tuned in while merely channel surfing. In alternative embodiments, the viewing timer may reside as a stand alone component or as a sub-component elsewhere.

Display processor 218 may also generate imagery 110 in response to viewer inputs received (and/or in response to instructions from command logic 205) to thereby make up a user interface that allows the viewer to select channels or programs, or to perform other tasks as desired. When the viewer provides inputs at keypad 122, indicator window 126 and/or quick reference area 128, for example, display processor 218 may be operable to draw (or redraw) imagery no in response, and/or to present television content identified by the viewer, as appropriate. As receiver 108 receives user inputs 125 from remote control 112, control logic 205 may direct display processor 218 to adjust any feature(s) of imagery no as directed by the viewer. Display processor 218 therefore directs the presentation of imagery no in conjunction with one or more navigation features, and adjusts the imagery no in response to inputs received from the viewer.

Display processor 218 produces an output signal encoded in any standard format (e.g., ITU656 format for standard definition television signals or any format for high definition television signals) that can be readily converted to standard and/or high definition television signals at interface 228. In other embodiments, the functionality of display processor 218 and interface 228 may be combined in any manner.

FIG. 3 shows an exemplary display imagery 110 that would allow a viewer to provide numeric or other symbol-based inputs using a remote control 112 with two-dimensional input capability. Other embodiments may incorporate imagery 110 of different sizes and configurations, and/or may allow for additional or other features in any manner. Practical views of imagery 110 presented on display 102 may vary widely from that shown in FIG. 3 without departing from the concepts discussed herein.

The exemplary imagery 110 of FIG. 3 may include a keypad 122, a symbol display window 124, a channel indicator window 126, and a quick reference area 128 as may be appropriate. In the embodiment shown, a viewer is able to move cursor 114 with respect to the various interface features to enter symbolic information using keypad 122, to choose an identifier 308A-D, to choose an identifier 309 A-D, to select a channel, program or other object, and/or to select a “quick reference” feature 310A-E for rapid retrieval of favorite or recently viewed identifiers. The various features shown in FIG. 3 may be implemented using any sort of symbology, programming and/or the like; in an exemplary embodiment, imagery 110 is generated by display processing module 218 (FIG. 2) in response to instructions from the viewer that are relayed by control logic 205.

Keypad 122 may be made to appear by manipulation one or more transducers, keys or key images on remote control 112 and may be any sort of interface feature capable of support viewer inputs of symbol-based data. In various embodiments, keypad 122 is virtual representation of a numeric, alphanumeric, alphabetical or other keyboard, although other embodiments may support different types of symbols, including foreign language symbols, shapes or other universal access symbols, and/or the like.

Keypad 122 includes any number of key images that each correspond to one or more symbols. In the exemplary embodiment shown in FIG. 3, keypad 122 includes twelve key images corresponding to ten numeric digits (0-9), with two additional key images 303, 305 provided for additional features as desired. Key 305, for example, could be selected to switch to an alphabetical keyboard of any sort. A conventional “QWERTY” or Dvorak-type keyboard could be displayed, for example, or a keypad with fewer key images could be presented, with multiple symbols assigned to each key image. Multiple letters could be assigned to a common key image, for example, and the viewer may be able to enter textual data using multiple “clicks” or other interactions for each key image, in a manner similar to that used for text entry in many conventional mobile phones. Other embodiments may omit alphabetic or alphanumeric entry entirely, or may provide other schemes for receiving alphanumeric data. Key 303 similarly provides any other desired feature. In various embodiments, key 303 may be used to provide a backspace, delete or other feature; other embodiments may use key 303 in a completely different manner, or may omit key 303 entirely.

The viewer provides symbol-based inputs in any manner. In various embodiments, the viewer guides cursor 114 over one or more key images associated with keypad 122 using the touchpad, motion sensor or other two-dimensional feature 127 associated with remote control 112. When the cursor 114 is positioned as desired, the viewer may be able to select the symbol associated with the key image by depressing a “select” or “enter” key, as appropriate. The “select” key may be a button or trigger on remote 112, for example, or may be any other interface feature as desired.

In various embodiments, symbols are presented in display window 124 as the viewer selects symbols in keypad 122. In the exemplary embodiment illustrated in FIG. 3, for example, the viewer has selected digits “1” and “9”, and these are shown in window 124. Some embodiments may provide a text cursor 306 that indicates a position in window 124 where symbol data will be entered. Text cursor 306 is shown as a simple horizontal line in FIG. 3, although other embodiments may implement this feature as a static or blinking line, block, rectangle or any other image. Still other embodiments may omit text cursor 306 altogether.

Information entered on keypad 122 and/or displayed in window 124 may be processed in any manner. In various embodiments, the information may be used to select a channel or program for decoding and presentation, for searching a disk, network or the like for content, and/or for any other purpose. In various embodiments, data entered into window 124 can be processed in a predictive manner. In the embodiment shown in FIG. 3, for example, numeric inputs from keypad 122 are used to select a channel to be tuned and presented by receiver 104. Identifier window 126 shows any number of identifiers 308A-D for objects that are referenced based upon symbol-based data entered by the viewer. As the viewer selects numeric or other symbolic data from keypad 122, for example, the identifiers 308A-D may be presented and/or updated as desired. Each identifier 308A-D represents any sort of object sought by the viewer; examples of such objects include programs, channels, networks, contents of programs, and/or the like. In the embodiment illustrated in FIG. 3, identifiers 308A-D represent particular channels that can be tuned by receiver 104 for presentation on display 102.

In addition, a recently viewed identifier window (i.e. the “previously viewed channel quick bar”) 317 may be included that shows a number of recently viewed identifiers 309 A-D. This recently viewed identifier window 317 may also be referred to as a “quick bar” or a “jump bar.” The recently reviewed identifiers are essentially the same symbology used for the identifiers 308 A-D but the identifiers are presented in order of the most recently viewed channels associated with identifier 309 A-D. The recently reviewed identifiers 309 A-D may be listed redundantly, or the latest viewing of a particular channel may delete or consolidate the recently viewed identifiers 309 A-D to avoid redundant presentation.

As a non-limiting example, if the latest sequence of channels viewed as indicated by identifiers 308 A-D was DIS, FOX, FOX, FOX, DIS, DIS, FOX, HIST, the recently viewed identifiers 309 A-C in recently viewed identifier window 317 may be displayed as DIS, FOX, HIST. In other embodiments, the presentation may also take frequency into account and may display FOX, DIS, HIST in the recently viewed identifiers window 317. Further, over time previously reviewed channel data becomes less relevant and as such, the data may be truncated or deleted. The time period for inclusion of an identifier 309 A-D in the frequently viewed identifier window 317 maybe truncated based on a calendar or other elapsed timing feature.

In various embodiments viewers may be able to immediately select a previously viewed channel associated with any identifier 309 A-D by simply selecting that identifier. The viewer may select any identifier 309A-D in any manner. In various embodiments, selection may occur by placing cursor 114 over the identifier 309A-D on imagery no, and then selecting the identifier 309A-D as appropriate. In the exemplary embodiment shown in FIG. 3, selection of an identifier 309A-D may result in receiver 104 tuning the channel associated with the selected identifier for presentation on display 102. Other actions could include setting a PVR to record a selected program, selecting a program for placeshifting, and/or taking any other action as desired.

Subsequent retrieval of recently viewed objects may optionally be provided in alternative embodiments. As a non-limiting example, FIG. 3 shows a quick reference area 128 that includes space for any number of quick reference features 310A-E associated with recently viewed objects 309 A-E. As a user views any channel, for example, a quick reference feature 310A-E is optionally associated with the relevant television channel and placed in area 128. The viewer is then able to quickly tune to the recently viewed channel by simply clicking on the featured 310A-E associated with the channel in area 128. Again, the features are not limited to quick access to television channels; other remembered features may include programs, networks, files and/or any other objects as desired.

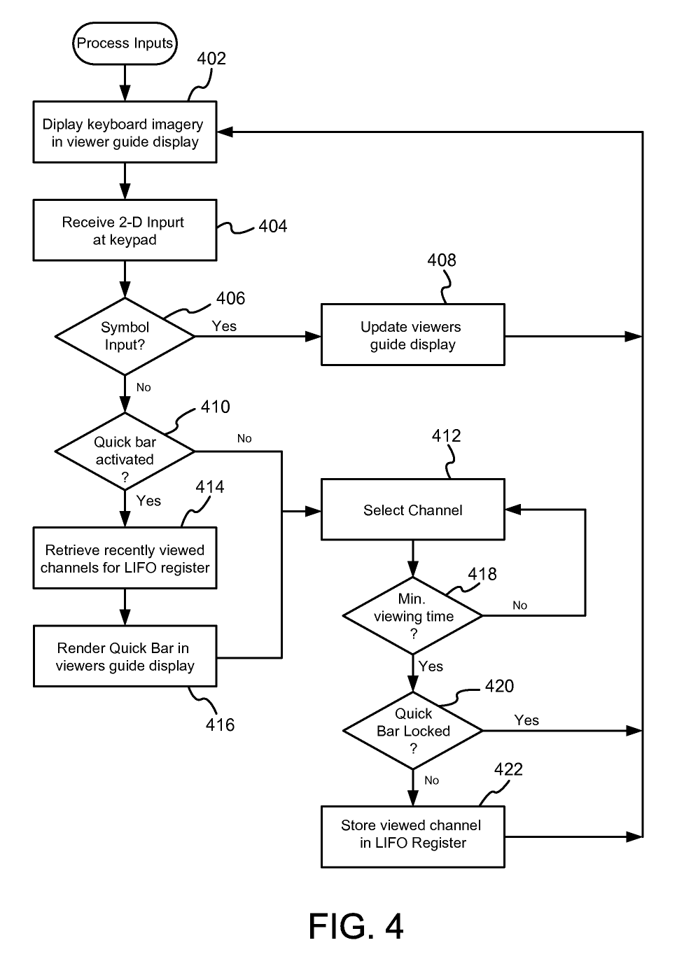

FIG. 4 shows an exemplary process 400 for graphically processing symbol-type inputs in a television receiver or the like. In various embodiments, the functions shown in FIG. 4 may be executed using source or object code in any format that may be stored in mass storage, firmware, memory or any other digital storage medium within receiver 104. Such code may be executed by any module or combination of modules operating within receiver 104. In an exemplary embodiment, some or all of the functions shown in process 400 are executed by control logic 205 (FIG. 2) operating alone or in conjunction with a display processing module 218, LIFO register 207 and/or the various other features shown in FIG. 2 and described above. While FIG. 4 specifically shows a technique for tuning channels on a television receiver, the concepts set forth in the figure and accompanying text could be used to perform other tasks, such as recording programs, selecting programs, searching and/or taking other actions as appropriate. The various functions and actions set forth in FIG. 4 may therefore be supplemented or otherwise modified in any manner.

With reference now to FIG. 4, an exemplary method 400 for processing numeric or other symbol-type data suitably includes the broad functions of displaying a keypad 122 (function 402), receiving inputs from a two-dimensional input device 127 (function 404), and then identifying (functions 406, 410, 418, 420) and processing (functions 408, 412, 414, 416, 422) the received inputs as appropriate to execute the various tasks directly or indirectly directed by the viewer. The functions of method 400 may take place in any other temporal order other than that shown in FIG. 4, and/or additional or alternate functions may be provided in alternate embodiments. The actual functions shown in FIG. 4 may be combined or omitted in still other embodiments.

Keypad 122 may be displayed in any suitable manner (function 402). In various embodiments, keypad 122 is any sort of numeric, alphanumeric or other keypad that generated and displayed by display processor 218 (FIG. 2), although other embodiments may generate the keypad in any other manner. As noted above, keypad 122 may suitably include any number of key images each corresponding to one or more letters, numbers and/or other symbols as desired and may suitably include a mouse pad/click button(s) 127.

Inputs may be received with respect to keypad 122 in any manner (function 404). In various embodiments, receiver 104 receives two-dimensional inputs from remote control 112 relating to a position of a cursor 114, as described above. The viewer is therefore able to position the cursor 114 over one or more key images and then indicate a selection of the key image in any manner.

Symbol input can be identified and processed in any manner (functions 406, 408). In various embodiments, symbol input is recognized from a selected cursor image corresponding to one or more key images in keypad 122. These inputs can be processed in any manner; symbols entered may be displayed (e.g., in window 124 or the like), for example, and/or the symbols may be used to update other portions of imagery no. Entered numerals, for example, could be used to update the channel indicators 308A-D displayed in window 126, or other features could be provided as appropriate to the particular embodiment.

In various further embodiments, other user interface features may also be provided. In embodiments such as the one shown in FIG. 3, for example, viewer selections of an indicator 308A-D/309A-D can be identified from two-dimensional inputs 125 received from remote 112, as described above.

Further, in some embodiments, the viewer may activate or deactivate the quick bar 317 by manipulating a button on keypad 122 or by other commonly known means. If the quick bar 317 is determined not to be activated (function 410), then the quick bar is not rendered along with imagery no in which case selections of an indicator 308 A-D (function 412) can be processed to tune a particular channel or program, or to take some other action as desired.

However, if the quick bar 317 is determined to be activated (function 410), then the quick bar is rendered (function 416) along with imagery no in which case selections of a indicator 308A-D/309A-D (function 412) can be processed to tune a particular channel or program, or to take some other action as desired. As a precursor to rendering the quick bar 317 in the imagery no, recently reviewed channels may be retrieved from storage (function 414) such as from the LIFO register 207 (FIG. 2).

Whether or not the quick bar 317 is activated, once a channel is selected (function 412) the minimum viewing timer 209 is initiated (function 418). The purpose for initiating the minimum viewing timer is to screen out channels that the viewer may pause on while surfing but not sufficiently long enough to actually be deemed as being “viewed”. If the minimum viewing timer 209 has not timed out before the viewer selects another channel, the timer resets. If the viewing timer 209 times out while the viewer is tuned into a single channel, the channel selection is consider to have been viewed. Of course after reading the Applicants disclosure herein one of ordinary skill in the art may appreciate that definition of “viewing” may be adjusted by adjusting a threshold time of the minimum viewing timer 209.

After it is determined that a particular channel is being viewed (function 418), then it is determined if the quick bar LIFO register 207 is locked (function 420) such that no additional data may be stored. If the quick bar LIFO register is locked (function 420) then additional information concerning newly viewed channels cannot be stored (function 422). Thereafter, selections of indicator 308 A-D (function 412) can be processed to tune a particular channel or program, or to take some other action as desired.

However, if the quick bar LIFO register 207 is determined to not to be locked (function 420) then data concerning the selected channel (function 412) may be stored to the quick bar LIFO register 207 for subsequent display in quick bar 317. After storage, the selection can be processed to tune a particular channel or program, or to take some other action as desired.

As a non-limiting example, the feature selected at function 412 may be included first in the recently viewed identifiers window 317 as representing the most recent channel viewed (Function 416). Previously viewed indicators 309 A-D would automatically be shifted by at least one position to indicate a viewing of at an earlier time. One of ordinary skill in the art will appreciate that if frequency of viewing is also made a factor, any shifting of previously viewed indicators 309 A-D may not occur at all or may result in a shift of more that one position in previously viewed indicator window 317.

In various embodiments, viewing a channel can result in a tile or other indicator 310 being placed in area 128 to allow the feature to be accessed at a later time via a “quick click” on the indicator 310 as appropriate. Upon selection of a quick reference indicator 310 (function 412), any action associated with the referenced feature may be executed as desired. A channel may be quickly tuned, for example, or any other action may be taken as desired. As noted above, the objects 310 present in area 128 may be further used to create a quick reference or favorites list that can be accessed from other views (e.g., EPG views) provided by receiver 108, as desired.

Accordingly, new systems and techniques are presented for graphically processing numeric, alphanumeric and/or other symbol-type information. Although the systems and features are generally described herein as applying to processing numeric features, equivalent embodiments could apply the same concepts to alphabetical, alphanumeric and/or any other types of symbol-based information, including selection of programs referenced in an EPG or stored on a DVR, selection of programs from a network host or other source, selection of programs for placeshifting, and/or any other features as desired.

As used herein, the word “exemplary” means “serving as an example, instance, or illustration.” Any implementation described herein as exemplary is not necessarily to be construed as preferred or advantageous over other implementations.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A method for modifying imagery on a display device to facilitate a user's navigation among programming channels, the method comprising:
storing recently viewed programming channel information in a last-in-first-out (LIFO) memory register, wherein the recently viewed programming channel information comprises previously viewed channel information and subsequently viewed channel information, the subsequently viewed channel information being stored after the previously viewed channel information in the order of viewing;
receiving a viewer instruction to render the imagery on the display device;
reading the recently viewed programming channel information from the LIFO register, wherein the previously viewed channel information is read from the LIFO memory register after the subsequently viewed programming channel information in reverse of the order of viewing;
modifying an imagery file associated with the imagery being rendered with the programming channel information; and
rendering the modified imagery to the user on the display device.

2. The method of claim 1, wherein the imagery file is an electronic programming guide (EPG) containing EPG information.

3. The method of claim 2, wherein modifying the imagery file comprises adding the recently viewed programming channel information to the EPG.

4. The method of claim 2, wherein modifying the imagery file comprises replacing EPG information with the recently viewed programming channel information.

5. The method of claim 1, wherein the viewer instruction to render the imagery on the display device is a two-dimensional user interface command.

6. The method of claim 1, wherein the previously viewed channel information comprises data associated with one or more viewed channels.

7. The method of claim 1, wherein the subsequently viewed channel information comprises data associated with one or more channels viewed after a previously viewed channel.

8. The method of claim 7, wherein the programming channel information contains redundant records of a particular viewed channel recorded within at least one of the previously viewed channel information and the subsequently viewed channel information.

9. The method of claim 1, wherein the LIFO register is optionally locked out or not locked out.

10. The method of claim 1, wherein receiving a viewer instruction to render the imagery on the display device includes:
selecting a channel;
determining whether a minimum viewing time has been achieved;
if the minimum viewing time has been achieved then storing data associated with the viewed channel as previously viewed channel data.

11. A method to create previously viewed data, comprising:
selecting a channel to be viewed;
determining whether a minimum viewing time has been achieved;
if the minimum viewing time has not been achieved then repeating the selecting and determining functions;
if the minimum viewing time has been achieved then storing data associated with the viewed channel as previously viewed channel data.

12. The method of claim 10, wherein the previously viewed channel data is stored in a last-in-first-out (LIFO) memory register.

13. The method of claim 10, wherein the previously viewed channel data is stored in the order in which the channel was viewed.

14. The method of claim 12, further including presenting the user with an option to disable storing data in the LIFO register associated with the viewed channel as previously viewed channel data.

15. A set top box comprising:
an interface to receive a video signal from a video signal source;
a decoder configured to extract a media stream from the video signal; and
a processor configured to render imagery derived from the media stream or from an on-screen display in response to a user input and to provide the rendered imagery to a display device, wherein the on-screen display is configured to identify indicia of recently viewed media streams.

16. The set top box of claim 15, further comprising a last-in-first-out (LIFO) memory register in operable communication with the processor, wherein the LIFO memory register records indicia of a plurality of recently viewed media streams in the reverse order of their being viewed.

17. The set top box of claim 16 wherein the LIFO register is optionally disabled from recording indicia of presently viewed media streams by a user.

18. The set top box of claim 15, further comprising a viewing timer in operable communication with the display processor, the viewing timer measuring the time during which the media stream has been displayed on the display device.

19. The set top box of claim 18 wherein the viewing timer is set to a threshold time limit, wherein
if the time limit is reached while the media stream is still being displayed, then saving an indicia of a the media stream into a memory register in operable communication with the display processor,
if the time limit is not reached then resetting the viewing timer to the time limit.

20. The set top box of claim 19 wherein the memory register is a last-in-first-out memory register.
